(19) United States
(12) Patent Application Publication
(10) Pub. No.: US 2015/0220350 A1
(43) Pub. Date: Aug. 6, 2015

(54) INFORMATION PROCESSING DEVICE AND METHOD FOR MANAGING INFORMATION PROCESSING DEVICE

(71) Applicant: FUJITSU LIMITED, Kawasaki-shi (JP)

(72) Inventor: Michiyuki KATSUMATA, Kawasaki (JP)

(73) Assignee: FUJITSU LIMITED, Kawasaki-shi (JP)

(21) Appl. No.: 14/606,335

(22) Filed: Jan. 27, 2015

(30) Foreign Application Priority Data
Feb. 3, 2014 (JP) 2014-018914

(51) Int. Cl. G06F 9/44; G06F 9/445

(52) U.S. Cl. CPC G06F 9/4416; G06F 9/44505

(57) ABSTRACT

An information processing system includes a plurality of information processing devices housed in a housing device, and a storage device that is mounted on the housing device and that stores pieces of start-up control information that each specify, for each of the plurality of information processing devices, a process to be performed by each of the plurality of information processing devices at the time of start-up, wherein an information processing device of the plurality of information processing devices, is configured to obtain corresponding start-up control information from the pieces of the start-up control information stored in the storage device at the time of the start-up of the information processing device, and perform a process that is specified by the obtained start-up control information.

### CROSS-REFERENCE TO RELATED APPLICATION

This application is based upon and claims the benefit of priority of the prior Japanese Patent Application No. 2014-018914, filed on Feb. 3, 2014, the entire contents of which are incorporated herein by reference.

### FIELD

The embodiments discussed herein are related to a technology for managing a plurality of information processing devices that are housed in a housing device, such as a chassis or a rack.

### BACKGROUND

In recent years, information processing devices have been widely used as servers that provide services for a user of another information processing device (hereinafter referred to as a “terminal device”) connected via a network. The provided services include a function mounted on a local device, data that a local device can access, or the like. A user who connects a terminal device to a network can use desired services via a server.

When the load for providing a service is heavy, or when the number of users of a terminal device who are assumed to be provided with a service is large, a server usually needs to have a high processing capacity. However, in many cases, there is no need to provide a server with a high processing capacity from the beginning. This is because, even if a server is made to provide a service with a heavy load, the number of users who are assumed to use the service is small in some cases.

The number of users often increases as the service continues to be provided. Alternatively, there is a case in which a new service commences being provided. Both the increase in the number of users and the provision of a new service increase a processing capacity needed for a server. In view of the foregoing, at present, the number of information processing devices used as a server is increased or decreased in accordance with the weight of a load for providing a service.

As an example, a blade server is a server that has a configuration in which one or more server blades that respectively function as one server (information processing device) are housed in a chassis. In the blade server, a processing capacity can be increased or decreased in accordance with the number of server blades housed in the chassis. In addition, the type of a CPU (Central Processing Unit) mounted on each of the server blades, the number of CPUs, or the like is not usually fixed. Therefore, in the blade server, a processing capacity can be increased or decreased by changing server blades.

A needed processing capacity is not always realized by one server. When the needed processing capacity is not realized by one server, another server is added. At present, there are many cases in which a service is provided using a plurality of servers.

A server blade or a server may be added when there is a breakdown of a server blade or a server during the operation. Therefore, the addition of a server blade or a server is not unusual.

Programs, e.g., an OS (Operating System), middleware, and an application program (hereinafter simply referred to as an “application”), need to be installed on a newly added server blade or server. However, programs to be installed sometimes vary according to a server blade or a server. Therefore, conventionally, a maintenance person individually installs needed programs on a server blade or a server by manual operation at the site.

The manual operation for installing programs on each server blade or server needs to be sequentially performed for each of the programs. Therefore, it takes a longtime to install programs for each of the server blades or the servers, and maintainability is low. When the number of server blades or servers on which programs need to be installed is large, it takes a huge amount of time to install the programs. Such a huge amount of time needed for maintenance may result in greatly reducing an operation rate of a server. Also considering the above, it is important to perform the maintenance of a newly added information processing device, such as a server blade or a server, as rapidly as possible. The same applies to a case of performing maintenance other than installing programs.

Technologies as described in the documents listed below are known.

Japanese Laid-open Patent Publication No. 2006-338225

Japanese Laid-open Patent Publication No. 2009-157597

Japanese Laid-open Patent Publication No. 6-141033

### SUMMARY

According to an aspect of the embodiment, an information processing system includes a plurality of information processing devices housed in a housing device, and a storage device that is mounted on the housing device and that stores pieces of start-up control information that each specify, for each of the plurality of information processing devices, a process to be performed by each of the plurality of information processing devices at the time of start-up, wherein an information processing device of the plurality of information processing devices, is configured to obtain corresponding start-up control information from the pieces of the start-up control information stored in the storage device at the time of the start-up of the information processing device, and perform a process that is specified by the obtained start-up control information.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an exemplary configuration of the information processing system according to an embodiment.

FIG. 2 illustrates an exemplary configuration of a management card.

FIG. 3 illustrates an exemplary configuration of a server blade.

FIG. 4 illustrates an exemplary configuration of an information processing device that is applicable as a host supervisory device.

FIG. 5 illustrates an exemplary configuration of chassis information according to the embodiment.

FIG. 6 illustrates an exemplary configuration of a start-up management table.

FIG. 7 is a flowchart of a transmission control process performed by a host supervisory device.

FIG. 8 is a flowchart of a CDM chassis information change process.

FIGS. 9A and 9B are flowcharts illustrating an exemplary flow of a process performed by a management card mounted on a blade server.

FIGS. 10A and 10B are flowcharts illustrating an exemplary flow of a process performed by an IPMC mounted on a server blade at the time of starting the server blade.

FIG. 11 is a flowchart of an OS start-up management process.

FIGS. 12A and 12B are sequence diagrams illustrating an exemplary flow of operations that are respectively performed by a host supervisory device, and a management board and a server blade of a blade server, when a maintenance person does not change chassis information.

FIGS. 13A and 13B are sequence diagrams illustrating an exemplary flow of operations that are respectively performed by a host supervisory device, and a management board and a server blade of a blade server, when a maintenance person changes chassis information.

FIGS. 14A and 14B are sequence diagrams illustrating an exemplary flow of operations that are respectively performed by a host supervisory device, and a management board and a server blade of a blade server, when a maintenance person changes chassis information (Continuation 1).

FIGS. 15A and 15B are sequence diagrams illustrating an exemplary flow of operations that are respectively performed by a host supervisory device, and a management board and a server blade of a blade server, when a maintenance person changes chassis information (Continuation 2).

### DESCRIPTION OF EMBODIMENTS

Embodiments are described below in detail with reference to the drawings.

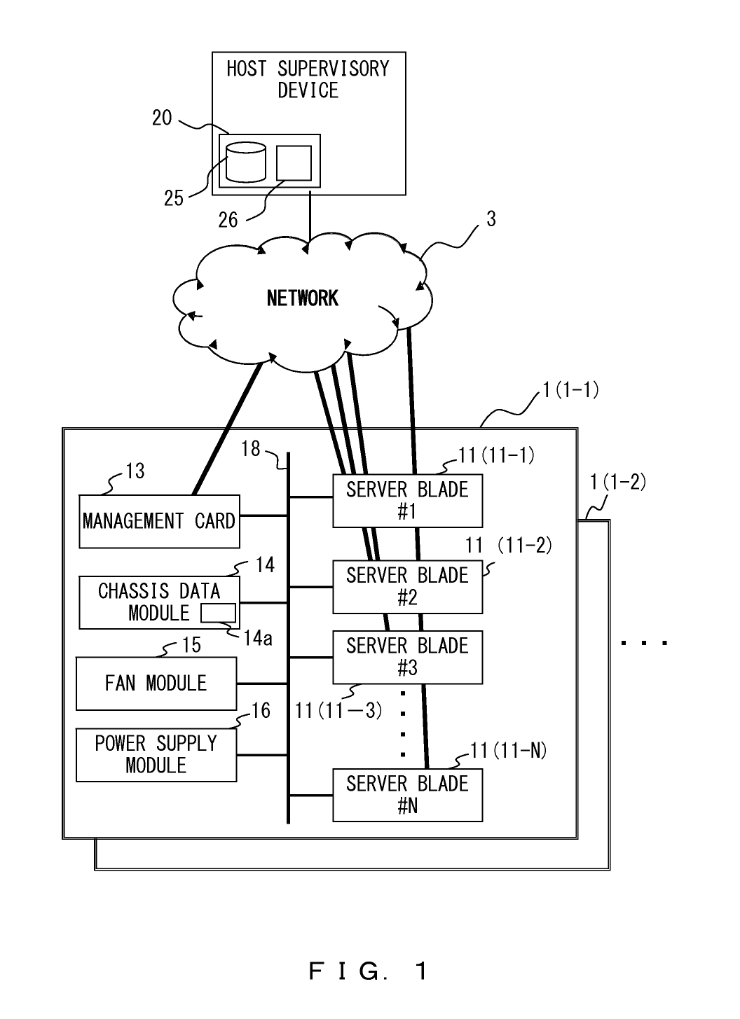

FIG. 1 illustrates an exemplary configuration of an information processing system according to the embodiment. The information processing system according to the embodiment is a system constructed in a data center, for example. As illustrated in FIG. 1, the information processing system has a configuration in which a plurality of blade servers 1 (1-1 and 1-2) and a host supervisory device 2 are connected to a network 3.

Each of the blade servers 1 corresponds to the information processing system according to the embodiment. Each of the blade servers 1 includes, in a chassis, a plurality of server blades 11 (11-1 to 11-N), a management card 13, a chassis data module 14, a fan module 15, and a power supply module 16. The plurality of server blades 11, the management card 13, the chassis data module 14, the fan module 15, and the power supply module 16 are respectively connected to an IPMB (Intelligent Platform Management Bus) 18. A configuration of the blade server 1 as illustrated in FIG. 1 is an example, and the configuration of the blade server 1 is not limited to the example illustrated in FIG. 1.

An IPMI (Intelligent Platform Management Interface) has a standard interface specification with which server management software enables server hardware to be monitored without depending on a specific hardware system or OS (Operating System). The IPMB 18 has an internal bus specification for the server management hardware, and the specification is included in the IPMI. An ICMB (Intelligent Chassis Management Bus) that has an external bus specification for connecting another IPMI system to a server is further included in the IPMI.

In the configuration above, the fan module is a module that drives a fan that is not illustrated. The power supply module 16 is a module that provides the blade server 1 with power.

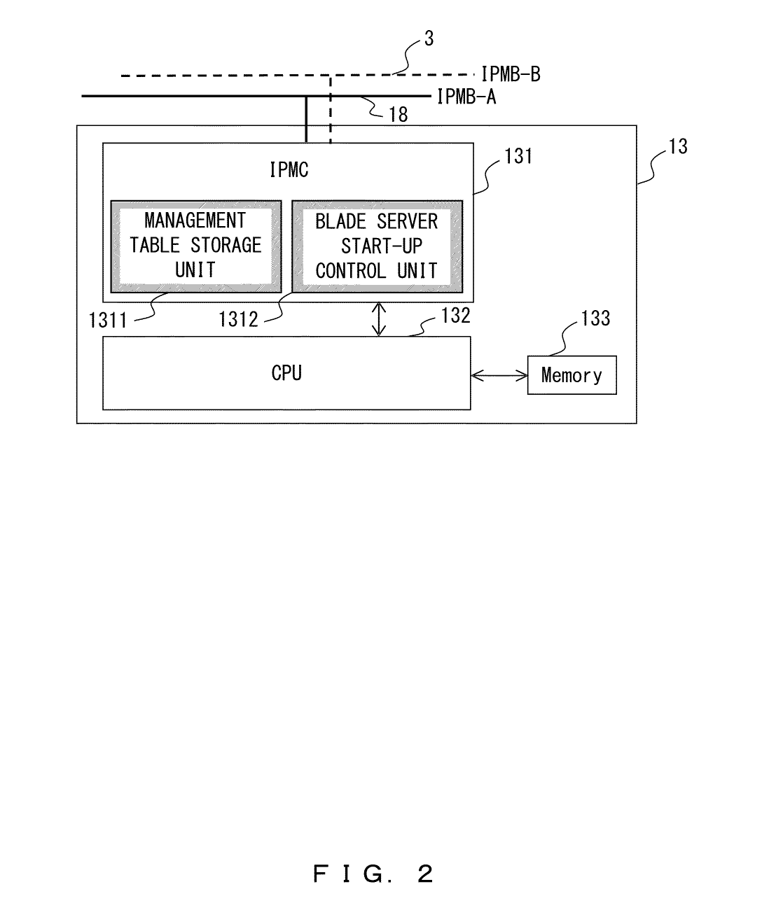

FIG. 2 illustrates an exemplary configuration of a management card. In FIG. 2, the IPMB 18 is referred to as an “IPMB-A”. An “IPMB-B” is an IPMB in the blade server 1 that is connected to the network 3, and is denoted by “3” in FIG. 2 in order to clarify a correspondence relationship with the network 3. In order to clarify a target with which communication is performed, hereinafter, the “IPMB-B” is referred to as a “network”.

The management card 13 is a management device of the blade server 1, and includes an IPMC (Intelligent Platform Management Controller) 131, a CPU 132, and a memory 133, as illustrated in FIG. 2.

The IPMC 131 performs power control (the control of the power supply module 16) or the like in accordance with an instruction from the host supervisory device 2 connected via the network. When power is turned on, each of the server blades 1 is started by performing a transition between the following states, which are specified in, for example, the ATCA (Advanced Telecom Computing Architecture) standard.
State 1 (S1): a power-off state
State 2 (S2): a start-up state
State 3 (S3): an active state
State 4 (S4): a power-on state

The ATCA standard described above is a hardware standard for computers for communication service providers. The ATCA standard specifies a shape of an outer frame (shelf), and a hardware specification of a card (blade) inserted into the outer frame (shelf). The ATCA standard specifies a function of removing or inserting a card in a power-on state (a hot-swap function) or the like, in addition to a size and a structure of a chassis. These specifications are established in consideration of a reliability or availability needed to provide communication services. A server conforming to the ATCA standard is capable of performing a communication process on each server blade on which a CPU or various chips are mounted. Therefore, a processing capacity of the entirety of a server can be enhanced by adding server blades.

A management table storage unit 1311 and a blade server start-up control unit 1312 are implemented on the IPMC 131 as a functional configuration. The descriptions thereof are given later.

Firmware executed by the CPU 132 is stored in the memory 133. The CPU 132 executes the firmware stored in the memory 133 so as to perform a process with a heavier load than that of a process performed by the IPMC 131.

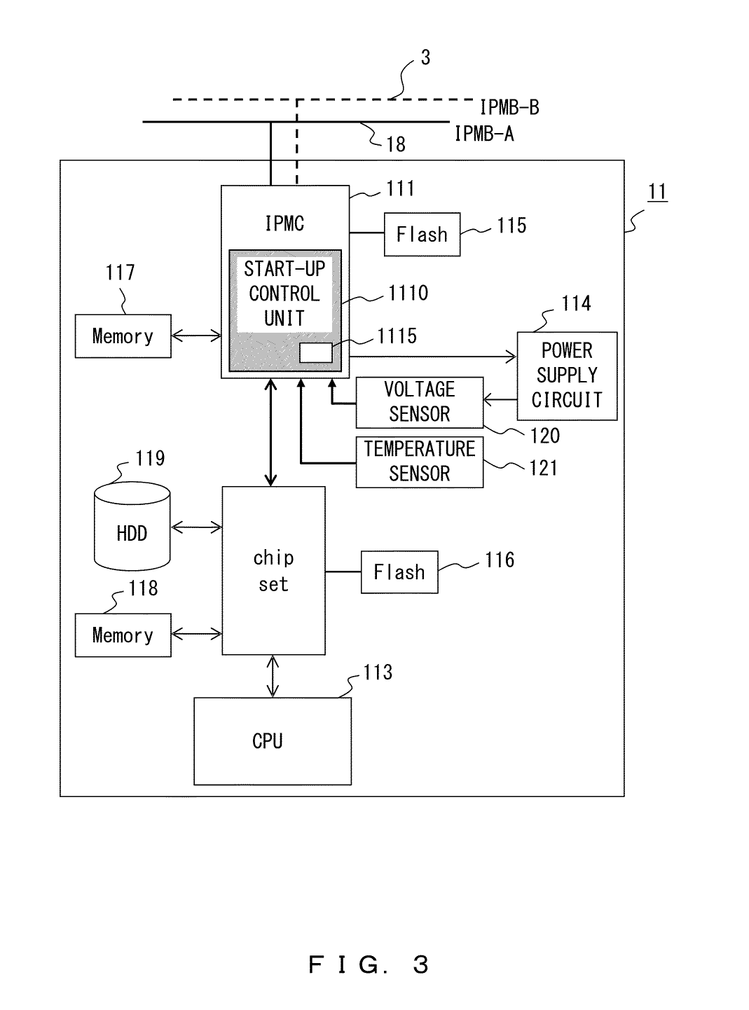

FIG. 3 illustrates an exemplary configuration of a server blade. FIG. 3 illustrates an “IPMB-A” and an “IPMB-B”, similarly to FIG. 2.

Each of the server blades 11 includes an IPMC 111, a chip set 112, a CPU 113, a power supply circuit 114, flash memories 115 and 116, memories 117 and 118, a hard disk device (HDD) 119, a voltage sensor 120, and a temperature sensor 121, as illustrated in FIG. 3.

A configuration of the server blade 11 as illustrated in FIG. 3 is an example, and the configuration of the server blade 11 is not limited to the example illustrated in FIG. 3. FIG. 3 illustrates only one power supply circuit 114, one voltage sensor 120, and one temperature sensor 121, but the server blade 11 usually includes a plurality of power supply circuits 114, voltage sensors 120, and temperature sensors 121. In addition, components that communicate with a network other than the network 3 are omitted.

Firmware executed by the CPU 113 is stored in the flash memory 116, and various programs executed by the CPU 113 are stored in the hard disk device 119. Here, for convenience, it is assumed that there are three types of programs for the various programs stored in the hard disk device 119, an OS, middleware, and an application.

The CPU 113 reads the firmware stored in the flash memory 116 in the memory 118 via the chip set 112, and starts the firmware. After starting the firmware, the CPU 113 sequentially reads the OS, the middleware, and the application in the memory 118 from the hard disk device 119 via the chip set 112, and starts them.

The IPMC 111 manages the start-up by the CPU 113, and monitors the voltage sensor 120 and the temperature sensor 121 under the control of the power supply circuit 114. The control above is realized by reading the firmware stored in the flash memory 115 in the memory 117 and executing the firmware.

A start-up control unit 1110 is implemented as a functional configuration on the IPMC 111 that executes the firmware stored in the flash memory 115. The start-up control unit 1110 has a function of causing the CPU 113 to perform a process to be performed, using a start-up management table 1115. The start-up management table 1115 and the start-up control unit 1110 are described later in detail.

The chassis data module (CDM) 14 is a non-volatile storage device mounted on the chassis, and is used for storing chassis information 14a. The chassis information 14a is information obtained by arranging pieces of information relating to the blade servers 1, and corresponds to start-up control information according to the embodiment.

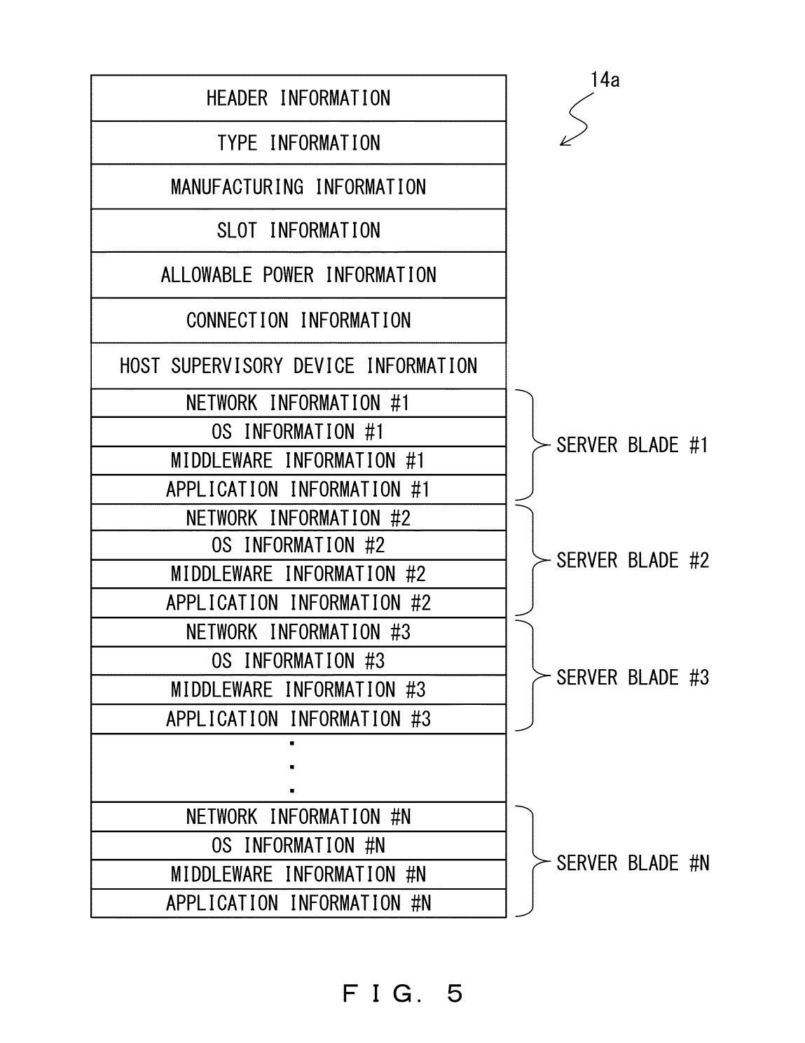

FIG. 5 illustrates an exemplary configuration of chassis information according to the embodiment. As illustrated in FIG. 5, the chassis information 14a includes header information, type information, manufacturing information, slot information, allowable power information, connection information, host supervisory device information, and a program information group for each of the server blades 11.

The header information is information that includes a data length of the chassis information 14a, or the like. The type information is information that indicates the type of the blade server 1, or the like. The manufacturing information is information relating to the manufacture of the blade server 1. The slot information is information that indicates the number of mounted server blades 11, or the like. The allowable power information is information that indicates a maximum allowable power value of the entirety of the blade server 1 or the server blades 11, or the like. The connection information is information relating to a backplane not illustrated. The network (IPMB-B) 3 and the IPMB-A 18 are a portion of the backplane. The host supervisory device information is information for accessing the host supervisory device 2, such as an IP (Internet Protocol) address.

Program information of each of the server blades 11 is information for causing a corresponding server blade 11 to download a program to be executed, and includes network information, OS information, middleware information, and application information. “#1”, “#2”, or the like illustrated in FIG. 5 denote a number that is given to each of the server blades 11 as identification information.

The OS information, the middleware information, and the application information are respectively pieces of information that specify a file of an OS, middleware, and an application to be downloaded by a corresponding server blade 11. The network information is information that specifies a network to be used for downloading a specified program. In the embodiment, it is assumed that various programs are downloaded from the host supervisory device 2. Therefore, the host supervisory device information is also used for downloading programs.

In the embodiment, the chassis information 14a that is configured as illustrated in FIG. 5 is employed so as to make each of the server blades 11 automatically download a needed program. Therefore, when server blades 11 are added, program information for each of the added server blades 11 may be added. This is because the added server blades 11 automatically download programs to be downloaded in accordance with corresponding pieces of program information.

The addition, the update or the like of program information is rapidly performed. A program is autonomously downloaded by the server blade 11. Therefore, a maintenance person does not need to install a program for each of the added server blades 11 by manual operation. Thus, a high maintainability can be obtained. The high maintainability enables rapid starting of an operation of a blade server 1 including added server blades 11 with a small workload, even if the number of added server blades 11 is large.

A storage unit 20 is mounted on the host supervisory device 2, and a program file group 25 and a chassis information group 26 are stored in the storage unit 20. The program file group 25 is an aggregate of program files in which programs to be downloaded by respective server blades 11 mounted in a blade server 1 are stored. The chassis information group 26 is an aggregate of pieces of chassis information 14a for respective blade servers 1.

As illustrated in FIG. 2, the management table storage unit 1311 and the blade server start-up control unit 1312 are implemented on the IPMC 131 that is mounted on the management board 13. The management table storage unit 1311 has a function of storing chassis information 14a received from the host supervisory device 2 in the CDM 14, and of storing chassis information 14a that is valid at that moment. The chassis information 14a that is valid at that moment is stored separately from the CDM 14 in order to recognize the updating of chassis information 14a in the CDM 14.

The blade server start-up control unit 1312 has a function of enabling a server blade 11 for downloading a program to be downloaded at the time of starting the server blade 11. A mode for downloading a program may be provided, and a program may be downloaded not at the time of starting a server blade 11 but at the time of setting the mode.

As illustrated in FIG. 3, a start-up control unit 1110 is implemented on the IPMC 111 that is mounted on each of the server blades 11. A start-up management table 1115 managed by the start-up control unit 1110 is a table that indicates whether each of the programs to be executed by the CPUs 113 of the server blades 11 needs to be downloaded. The start-up control unit 1110 refers to the start-up management table 1115, and makes the CPU 113 download a needed program. The start-up management table 1115 is data stored in the flash memory 115.

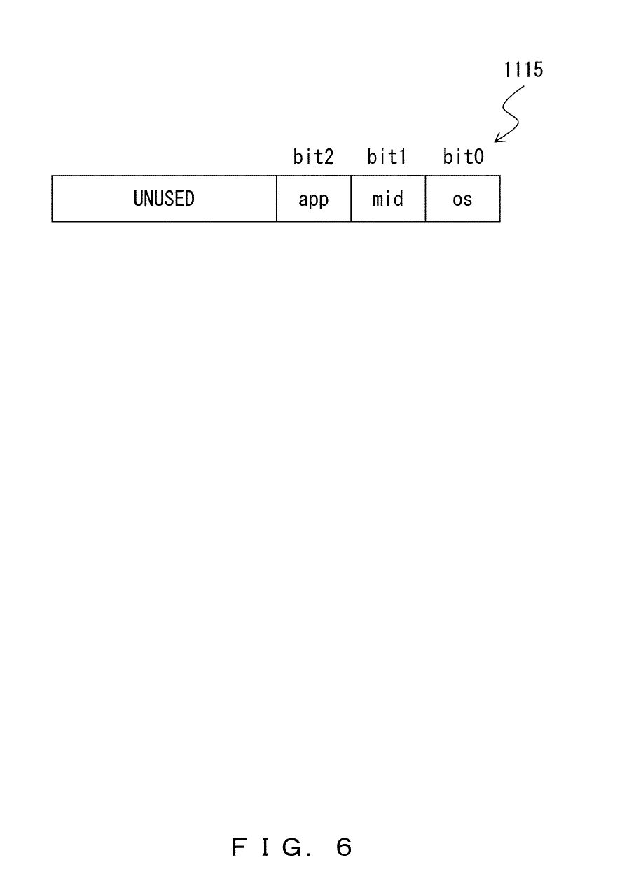

FIG. 6 illustrates an exemplary configuration of a start-up management table. The exemplary configuration illustrated in FIG. 6 is a configuration in a case in which it is assumed that there are only three types of programs executed by the CPU 113, an OS, middleware, and an application, as described above. In FIG. 6, “app”, “mid”, and “OS” respectively indicate an application, middleware, and an OS.

The start-up management table 1115 has a flag for each of the programs. Each of the flags is 1-bit data. A value of 0 indicates that a program has not been downloaded (installed), and a value of 1 indicates that a program has been downloaded. Therefore, the start-up control unit 1110 makes the CPU 113 download a program whose flag has a value of 0. Hereinafter, a flag for an OS is referred to as an “OS flag”. Similarly, a flag for middleware is referred to as a “mid flag”, and a flag for an application is referred to as an “app flag”.

A program whose flag has a value of 0 is automatically installed, and therefore a server blade 11 on which programs other than firmware have not been installed may be housed in a chassis in a state in which all of the flags in the start-up management table 1115 have a value of 0. In a server blade 11 on which all of the programs to be installed have been installed, all of the flags in the start-up management table 1115 may be set so as to have a value of 1.

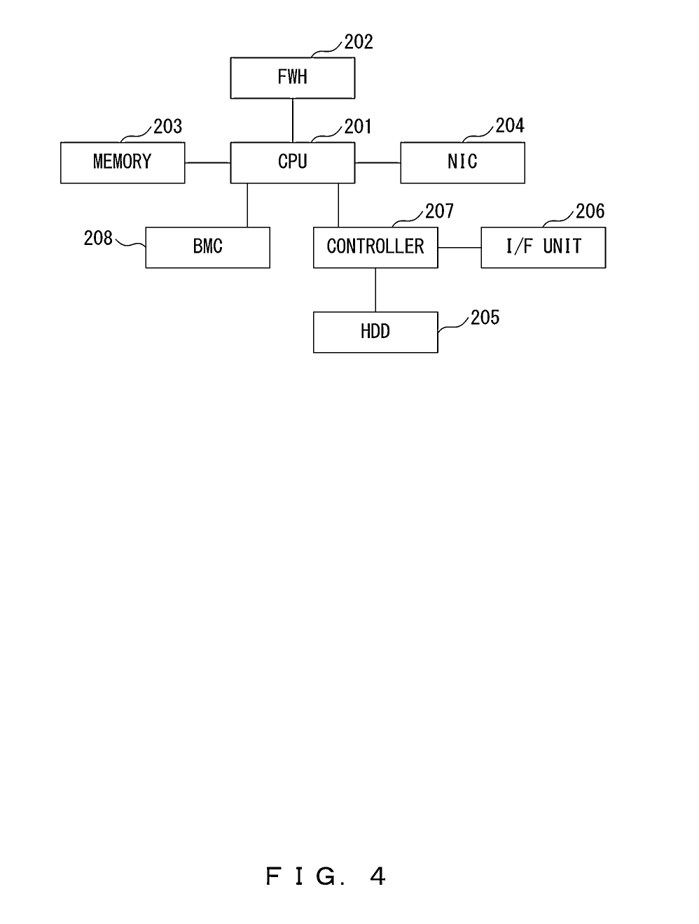

An information processing device having the exemplary configuration illustrated in, for example, FIG. 4 can be employed for the host supervisory device 2 that mounts the storage unit 20 described above. With reference to FIG. 4, an information processing device applicable to the host supervisory device 2 is described below in detail.

The information processing device that is applicable to the host supervisory device 2 includes, for example, a CPU 201, an FWH (Firm-Ware Hub) 202, a memory (memory module) 203, an NIC (Network Interface Card) 204, a hard disk device (HDD) 205, an I/F unit 206, a controller 207, and a BMC (Baseboard Management Controller) 208, as illustrated in FIG. 4. This configuration is an example, and a configuration of the information processing device that is applicable to the host supervisory device 2 is not limited to the configuration as illustrated in FIG. 4.

The FWH 202 is a memory in which firmware is stored. The firmware is read in the memory 203 by the CPU 201, and is executed. An OS, an application for performing control as the host supervisory device 2 (hereinafter referred to as a “host supervisory program”), and the like are stored in the hard disk device 205. After the start-up of firmware is completed, the CPU 201 reads the OS and the host supervisory program from the hard disk device 205 via the controller 207, and executes the OS and the host supervisory program. Communication via the NIC 204 is enabled after the OS is started.

The host supervisory program may be stored in a storage other than the hard disk device 205, or a recording medium. The storage or the recording medium may be accessible from an external device with which the NIC 204 can communicate via a network (e.g., the network 3). Therefore, the host supervisory program may be received from the external device.

The I/F unit 206 is a component that enables a maintenance person to input various pieces of data. Assuming that an input device that the maintenance person uses for inputting data is a keyboard, a touch panel, a console, or the like, the I/F unit 206 provides an interface for connecting the input device. Assuming that the input device is a terminal device, the I/F unit 206 provides an environment in which communication is performed with the terminal device. Here, it is assumed for convenience that the terminal device is connected to the I/F unit 206.

The BMC 208 is a dedicated management device for managing an information processing device. The BMC 208 performs turning on or off of the CPU 201, monitors errors that occur in respective components, or other operations.

The BMC 208 usually supports IPMB connections. Therefore, it is assumed here that the network 3 is connected to the BMC 208.

In an information processing device having the configuration above, the storage unit 20 is the hard disk device 205. Assuming that the network 3 is connected to the BMC 208, the control by way of the host supervisory device 2 is realized by cooperation between the BMC 208 and the CPU 201. As a result, the control is realized by the CPU 201, the FWH 202, the memory 203, the hard disk device 205, the I/F unit 206, the controller 207, and the BMC 208. The CPU 201, which executes the host supervisory program stored in the hard disk device 205, performs storing or updating of a chassis information group 26, storing or updating of a program file group 25, or other operations in accordance with data input that is performed as a result of an operation of the terminal device by a maintenance person. In addition, the CPU 201 controls the transmission/reception of data via the BMC 208 so as to realize the transmission of chassis information 14a, the transmission of a program, or the like to the blade server 1.

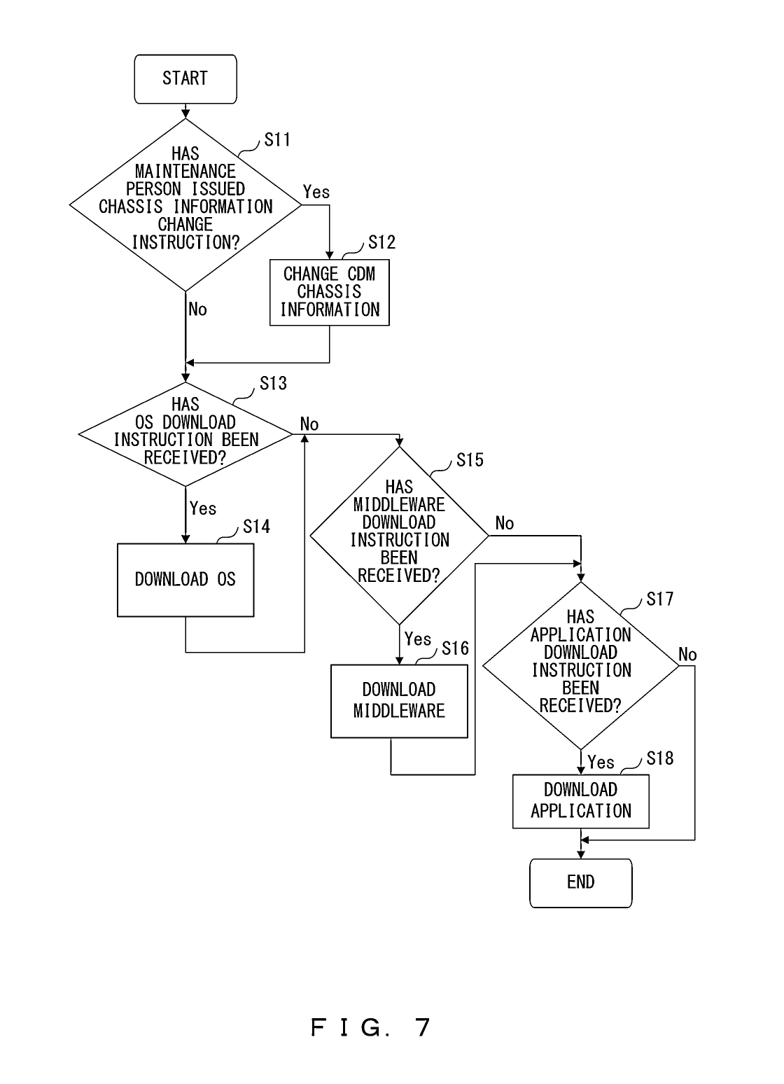

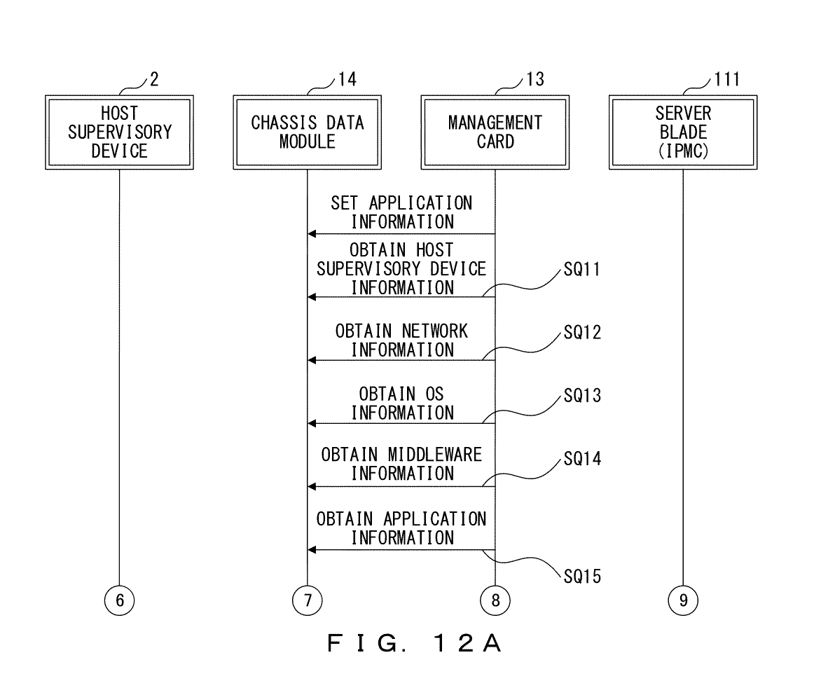

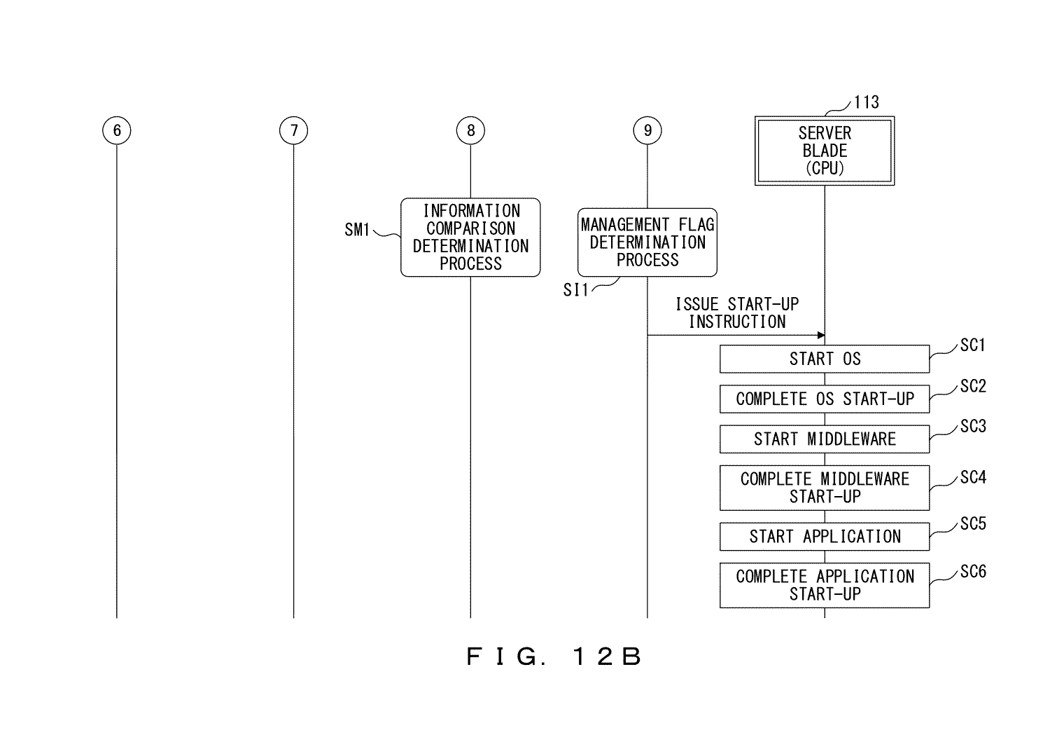

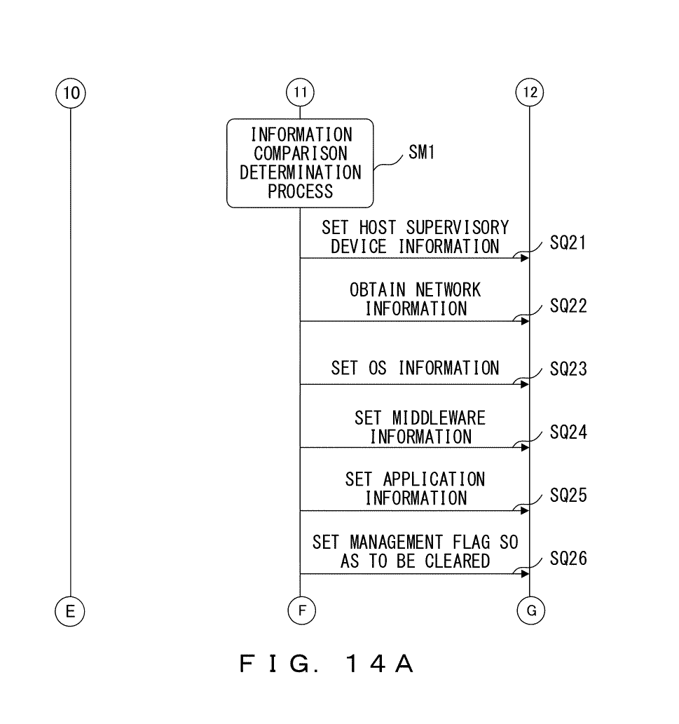

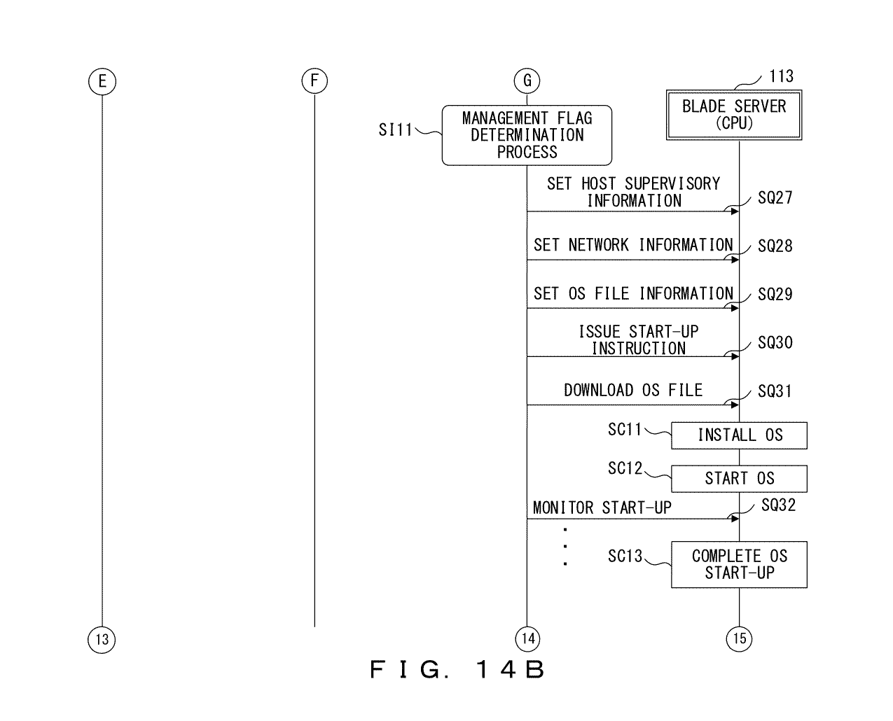

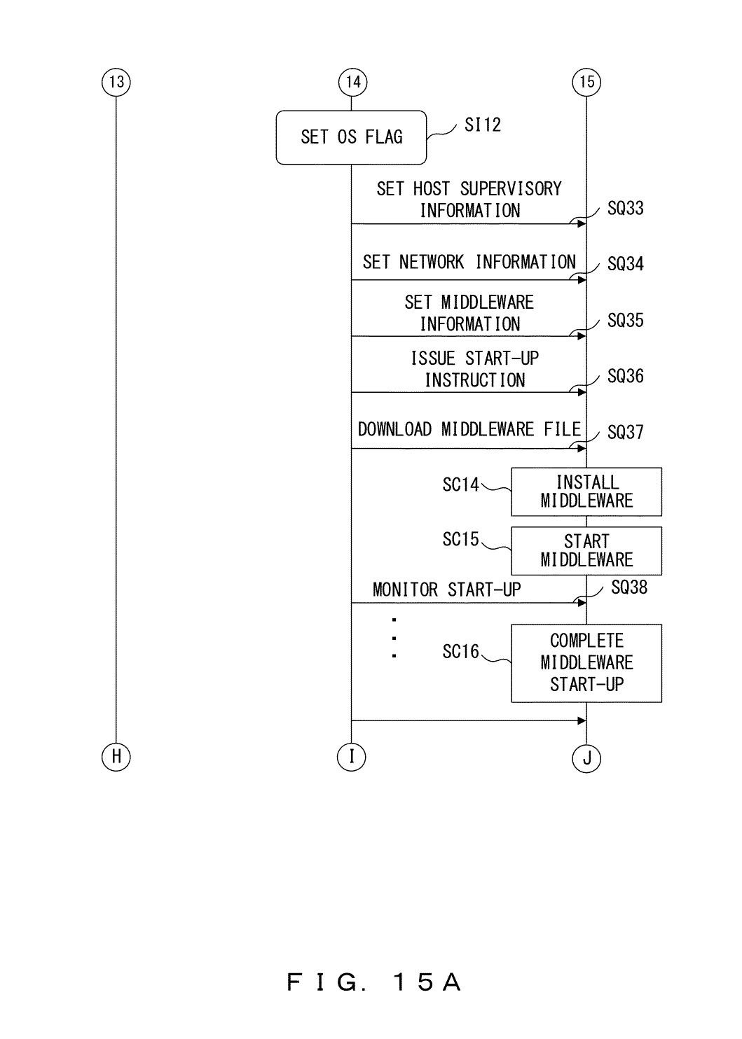

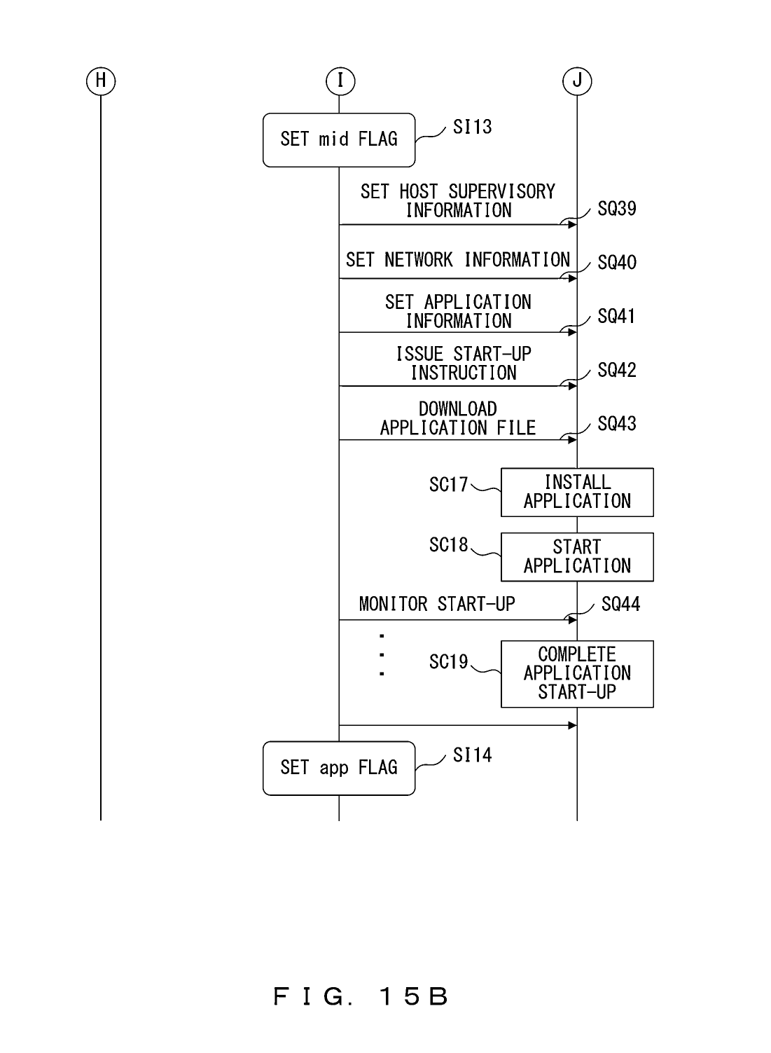

Next, operations of the host supervisory device 2 and the blade server 1 are described in detail with reference to respective flowcharts illustrated in FIGS. 7-11 and respective sequence diagrams illustrated in FIGS. 12-15.

FIG. 7 is a flowchart of a transmission control process performed by the host supervisory device. The transmission control process is a process that the CPU 201 performs in order to transmit data to be transmitted or requested data to the blade server 1. The transmission control process is performed in response to the generation of the data to be transmitted, or the reception of a data transmission request. First, with reference to FIG. 7, the transmission control process is described in detail. In FIG. 7, it is assumed that an example of the generation of the data to be transmitted is only the update of chassis information (also referred to as “CDM chassis information” in FIG. 7) 14a in one of the blade servers 1.

First, the CPU 201 determines whether a maintenance person has issued a change instruction for chassis information 14a (S11). When the maintenance person operates a terminal device connected to the I/F unit 206 so as to issue an instruction to change the chassis information 14a, the determination in S11 is “Yes”, and the process moves on to S12. When the maintenance person does not connect the terminal device to the I/F unit 206, or does not operate the terminal device so as to issue an instruction to change the chassis information 14a, the determination in S11 is “No”, and the process moves on to S13.

In S12, the CPU 201 performs a CDM (chassis data module) chassis information change process for changing chassis information 14a specified by the maintenance person in accordance with an operation of the terminal device by the maintenance person. After performing the CDM chassis information change process, the process moves on to the process above of S13.

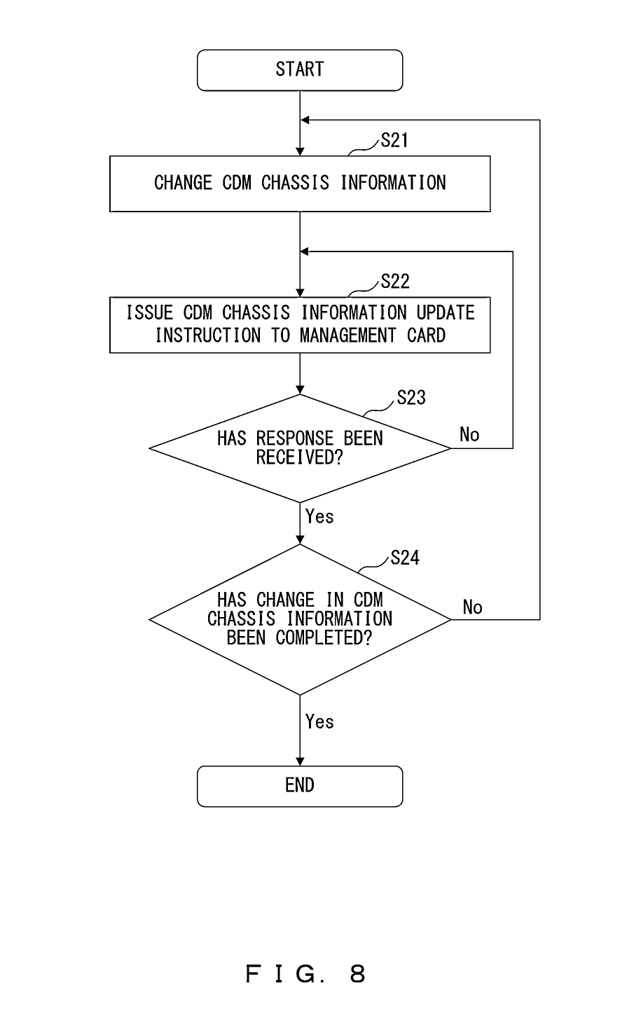

FIG. 8 is a flowchart of the CDM chassis information change process. Here, with reference to FIG. 8, the CDM chassis information change process is described in detail.

A change in chassis information 14a includes the addition of new chassis information 14a to the chassis information group 26. Chassis information 14a to be changed is selected by a maintenance person, and the change is performed for each piece of information forming the chassis information 14a. FIG. 8 illustrates only processes of changing chassis information 14a selected by the maintenance person.

First, the CPU 201 changes information specified by a maintenance person in response to an operation of the terminal device by the maintenance person (S21). This change is performed on the chassis information group 26.

Next, the CPU 201 issues (transmits) an update instruction for chassis information 14a to a management board 13 of a blade server 1 in which the chassis information 14a has been changed (S22). The update instruction includes at least a changed portion in the chassis information 14a.

An IPMC 131 in the management board 13 which has received the update instruction updates the chassis information 14a in a CDM 14 in accordance with the update instruction, and returns a reply indicating an update result. Therefore, the CPU 201 waits to receive the reply after transmitting the update instruction (S23). After receiving the reply, the CPU 201 determines whether a change in the chassis information 14a has been completed (S24).

Instructions to complete the change in the chassis information 14a are supposed to be given by a maintenance person. When the maintenance person operates the terminal device so as to issue an instruction to complete the change in the chassis information 14a, the determination in S24 is “Yes”, and the CDM chassis information change process is finished. When the maintenance person does not issue the instruction, the determination in S24 is “No”, and the process returns to the process above of S21. As a result, the maintenance person can further change the chassis information 14a.

The description returns to FIG. 7.

After performing the CDM chassis information change process as described above, the process moves on to S13. In S13, the CPU 201 determines whether an instruction to download an OS has been received. When the BMC 208 receives the instruction, the determination in S13 is “Yes”, the CPU 201 reads an OS requested by the instruction from the hard disk device 205, and transmits the OS to the BMC 208 (S14). Then, the process moves on to S15. When the BMC 208 does not receive the instruction to download an OS, the determination in S13 is “No”, and the process moves on to S15.

In S15, the CPU 201 determines whether an instruction to download middleware has been received. When the BMC 208 receives the instruction, the determination in S15 is “Yes”, and the CPU 201 reads middleware requested by the instruction from the hard disk device 205, and transmits the middleware to the BMC 208 (S16). Then, the process moves on to S17. When the BMC 208 does not receive the instruction to download middleware, the determination in S15 is “No”, and the process moves on to S17.

In S17, the CPU 201 determines whether an instruction to download an application has been received. When the BMC 208 receives the instruction, the determination in S17 is “Yes”, and the CPU 201 reads an application requested by the instruction from the hard disk device 205, and transmits the application to the BMC 208 (S18). Then, the transmission control process is finished. When the BMC 208 does not receive the instruction to download an application, the determination in S17 is “No”, and the transmission control process is finished at this point.

As described above, the chassis information 14a is transmitted to a blade server 1 to which the chassis information 14a is to be transmitted (a management board 13 thereof) by changing the chassis information 14a, and a program requested by the blade server 1 is transmitted to the blade server 1 in response to the request. As a result, respective server blades 11 mounted on the blade servers 1 can download needed programs from the host supervisory device 2 as needed.

Chassis information 14a in each of the blade servers 1 is automatically updated as a result of the update of chassis information 14a stored in the host supervisory device 1. Therefore, a maintenance person can easily update chassis information 14a of an arbitrary blade server 1. The installation of a program that is performed by each of the server blades 11 provided in a blade server 1 is controlled by chassis information 14a. Therefore, a maintenance person can easily perform the installation of a program performed by each of the server blades 11.

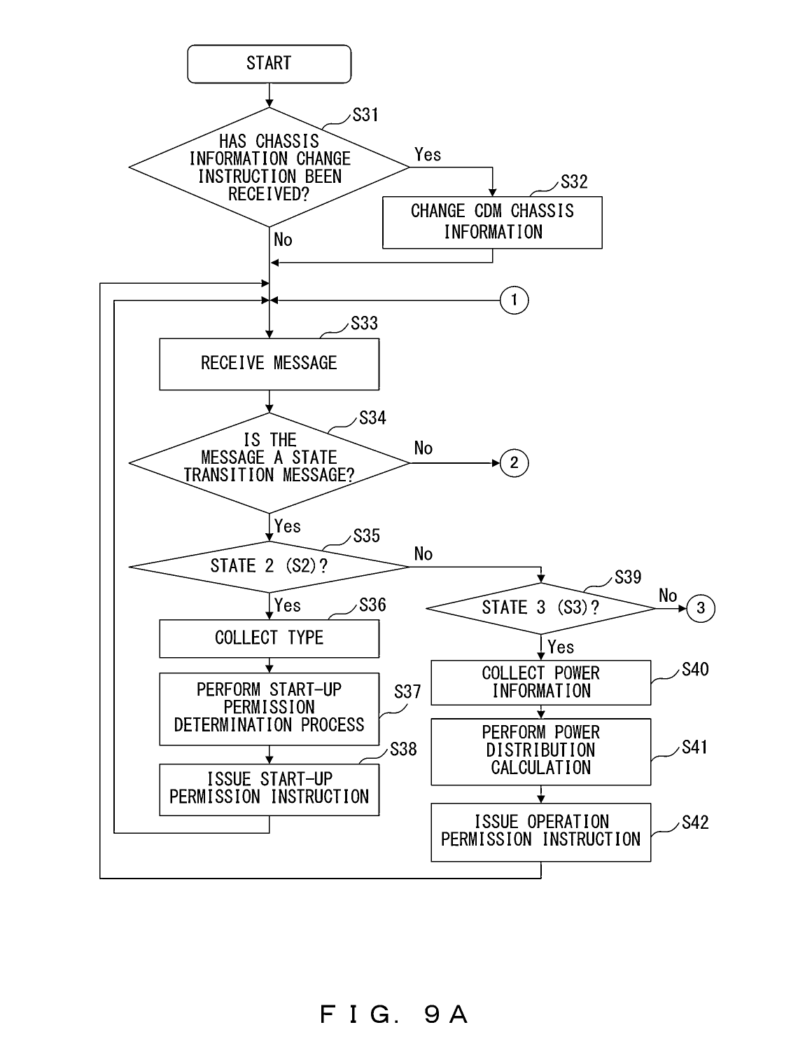

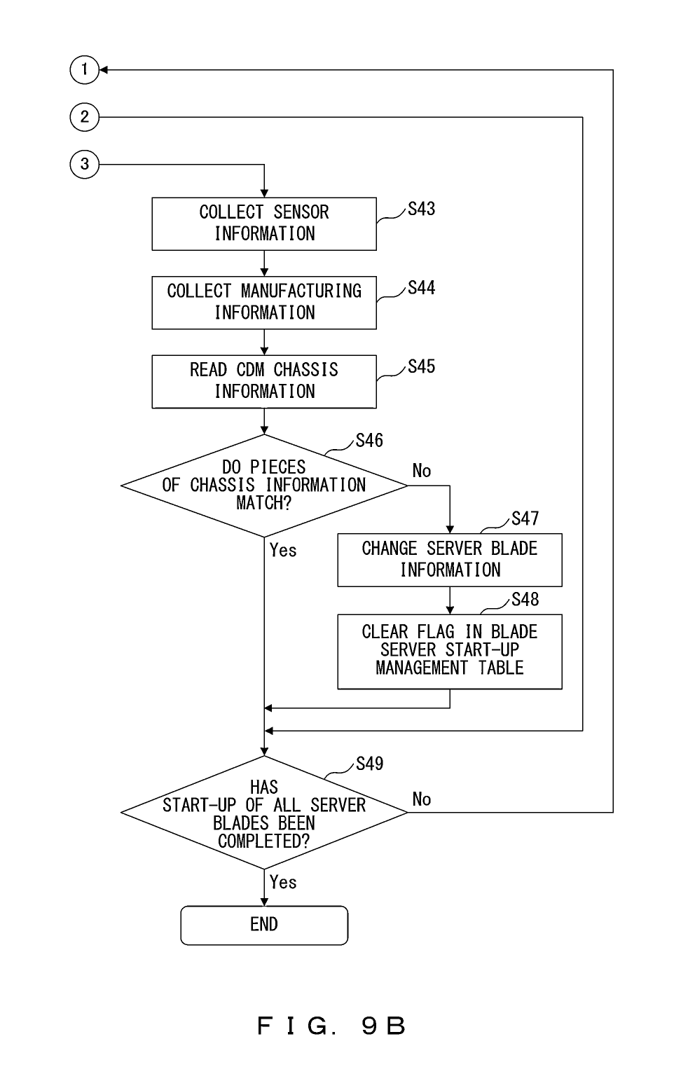

FIGS. 9A and 9B are flowcharts illustrating an exemplary flow of a process performed by a management card mounted on a blade server. The process flow illustrated in FIGS. 9A and 9B is an example of a process flow in a case in which a server blade 11 is started after an instruction to change chassis information 14a is addressed, and the process illustrated in FIGS. 9A and 9B is performed by an IPMC 131 mounted on a management card 13. Next, with reference to FIGS. 9A and 9B, a process that is performed by the IPMC 131 mounted on the management card 13 is described in detail.

First, the IPMC 131 determines whether a change instruction for chassis information 14a has been received from the host supervisory device 2 (S31). When the change instruction is received, the determination in S31 is “Yes”, and the process moves on to S32. When the change instruction is not received, the determination in S31 is “No”, and the process moves on to S33.

In S32, the IPMC 131 performs change so as to rewrite corresponding information in the chassis information 14a stored in the CDM 14 in accordance with the received change instruction. Then, the process moves on to S33.

The process of S31 is a process that is performed every time a message is received from the host supervisory device 2. Therefore, the updating of the chassis information 14a stored in the CDM 14 is also performed every time the change instruction is received from the host supervisory device 2. In this example, it is assumed for convenience of explanation that only one change instruction is addressed. The management table storage unit 1311 is realized by performing the processes of S31 and S32 in response to the reception of a change instruction. The blade server start-up control unit 1312 is realized by performing the process of S33 and the processes that follow. In the process of S33 and the processes that follow, it is assume that each of the server blades 11 is started in accordance with an instruction from the host supervisory device 2, an instruction from a maintenance person, or a preset schedule.

In S33, the IPMC 131 waits to receive a message from a started server blade 11. When the IPMC 131 receives the message, the IPMC 131 determines whether the received message is a state transition message reporting a state transition (S34). When the IPMC 131 receives a state transition message, the determination in S34 is “Yes”, and the process moves on to S35. When the IPMC 131 receives a message other than a state transition message, the determination in S34 is “No”, and the process moves onto S49. In FIGS. 9A and 9B, processes of addressing a message other than a state transition message are omitted.

In S35, the IPMC 131 determines whether a state reported by the state transition message is state 2 (S2: start-up state). When the state reported by the state transition message is state 2, the determination in S35 is “Yes”, and the process moves on to S36. When the state reported by the state transition message is not state 2, the determination in S35 is “No”, and the process moves on to S39.

In S36, the IPMC 131 collects type information in the chassis information 14a stored in the CDM 14. Next, the IPMC 131 performs a start-up permission determination process for determining whether the server blade 11 that has been transited to state 2 may be started (S37). As a result of performing the start-up permission determination process, when the IPMC 131 determines that the server blade 11 may be started, the IPMC 131 issues a start-up permission instruction to the server blade 11 (S38). Then, the process returns to the process above of S33.

In S39, the IPMC 131 determines whether a state reported by the state transition message is state 3 (S3: active state). When the state reported by the state transition message is state 3, the determination in S39 is “Yes”, and the process moves on to S40. When the state reported by the state transition message is not state 3, the determination in S39 is “No”, and the process moves on to S43.

In S40, the IPMC 131 collects allowable power information in the chassis information 14a stored in the CDM 14. Next, the IPMC 131 performs power distribution calculation to specify power that is distributable to a server blade 11 that has been transited to state 3 (S41). After performing the power distribution calculation, the IPMC 131 issues an operation permission instruction to the server blade 11 (S42). After the operation permission instruction is issued, the process moves on to the process above of S33.

In S43, the IPMC 131 collects sensor information (e.g., sense values of the voltage sensor 120, the temperature sensor 121, and the like) that is received as a message from the server blade 11 to which the operation permission instruction has been issued. Next, the IPMC 131 collects manufacturing information in the chassis information 14a stored in the CDM 14 (S44). Then, the IPMC 131 reads program information in the server blade 11 from which the sensor information in the chassis information 14a stored in the CDM 14 has been collected (S45).

Next, the IPMC 131 determines whether the read program information matches program information in chassis information 14a stored in the IPMC 131 (S46). When the pieces of program information are completely matched, the determination in S46 is “Yes”, and the process moves on to S49. When the pieces of program information are mismatched even partially, the determination in S46 is “No”, and the process moves on to S47.

In S47, the IPMC 131 changes the program information stored in the IPMC 131 to the program information of the chassis information 14a stored in the CDM 14. Next, the IPMC 131 updates a start-up management table 1115 of a server blade 11 in which pieces of program information are mismatched, in accordance with mismatched information in the program information (S48). This update is performed by clearing a flag corresponding to the mismatched information in the program information. After the start-up management table 1115 is updated as described above, the process moves on to S49.

In S49, the IPMC 131 determines whether the start-up of all of the server blades 11 has been completed. When there are any server blades 11 from which sensor information has not been collected, the determination in S49 is “No”, and the process returns to the process above of S33. When there are no server blades 11 from which sensor information has not been collected, the determination in S49 is “Yes”, and the series of processes is finished at this point.

As described above, the start-up management table 1115 that each of the server blades 11 manages is updated in accordance with the updating of corresponding program information in the chassis information 14a stored in the CDM 14. As a result, a maintenance person can make each of the server blades 11 execute a program to be executed by updating program information in the host supervisory device 2.

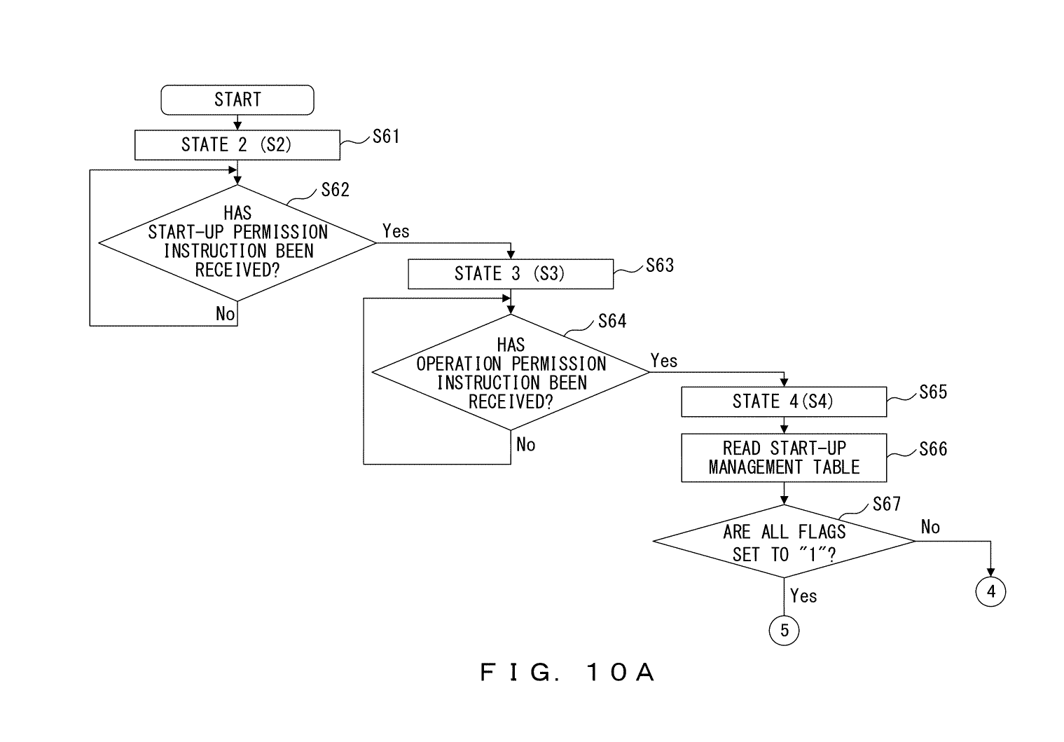

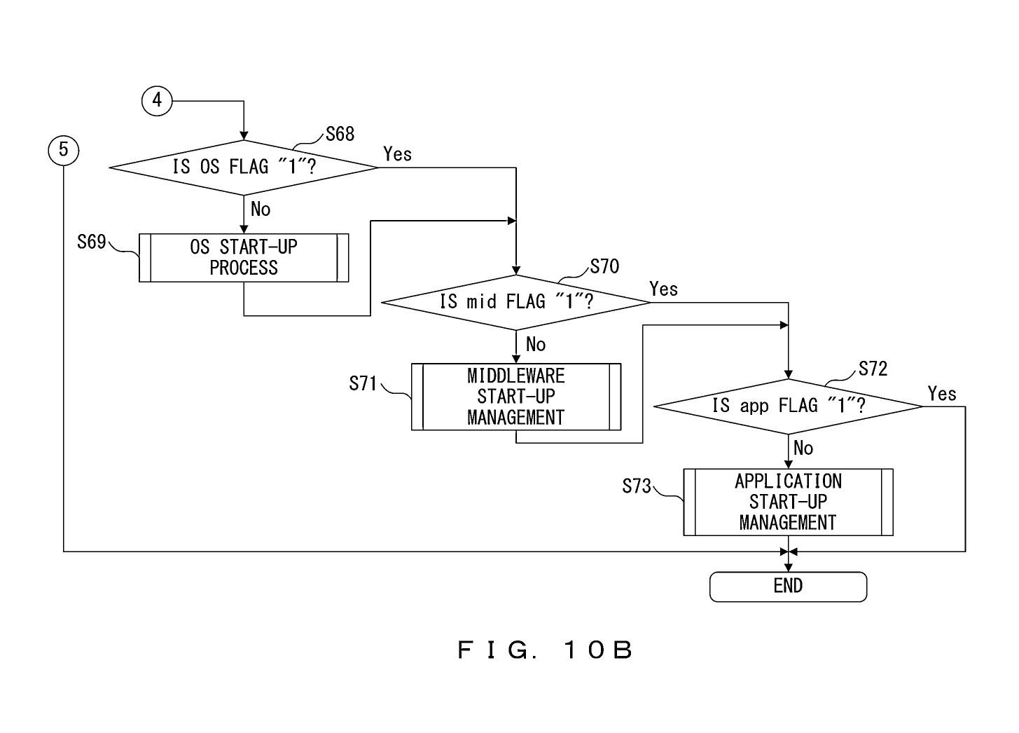

FIGS. 10A and 10B are flowcharts illustrating an exemplary flow of a process that is performed by an IPMC mounted on a server blade when the server blade is started. Next, with reference to FIGS. 10A and 10B, a process that is performed by an IPMC 111 mounted on a server blade 11 when the server blade 11 is started is described in detail. The start-up control unit 1110 is realized by the IPMC 111 performing the process illustrated in FIGS. 10A and 10B.

First, the IPMC 111 transits from state 1 (S1) to state 2 (S2) in response to a start-up instruction from a management card 13, and reports to the management card 13 that the transition has been performed (S61). Next, the IPMC 111 waits to receive a start-up permission instruction from the management card 13 (S62). When the IPMC 111 receives the start-up permission instruction, the process moves on to S63.

In S63, the IPMC 111 transits to state 3 (S3) in response to the reception of the start-up permission instruction, and reports to the management card 13 that the transition has been performed. Then, the IPMC 111 waits for the reception of an operation permission instruction from the management card 13 (S64). When the IPMC 111 receives the operation permission instruction, the process moves on to S65.

In S65, the IPMC 111 transits to state 4 (S4) in response to the reception of the operation permission instruction, and reports to the management card 13 that the transition has been performed. Next, the IPMC 111 reads the start-up management table 1115 (S66) and determines whether all of the flags in the start-up management table 1115 have a value of 1 (S67). When all of the flags have a value of 1, the determination in S67 is “Yes”, and a series of processes is finished after making the CPU 113 start an OS, middleware, and an application. When any of the flags have a value of 0, the determination in S67 is “No”, and the process moves on to S68.

In S68, the IPMC 111 determines whether a value of an OS flag is 1. When an OS does not need to be downloaded, a value of the OS flag is 1, and therefore the determination in S68 is “Yes”, and the process moves on to S70 after instructing the CPU 113 to start an OS. When a value of the OS flag is 0, the determination in S68 is “No”, and the process moves on to S69.

In S69, the IPMC 111 downloads an OS to be downloaded, and performs an OS start-up management process for making the CPU 113 start the downloaded OS. Then, the process moves on to S70.

In S70, the IPMC 111 determines whether a value of a mid flag is 1. When middleware does not need to be downloaded, a value of the mid flag is 1, and therefore the determination in S70 is “Yes”, and the process moves on to S72 after instructing the CPU 113 to start middleware. When a value of the mid flag is 0, the determination in S70 is “No”, and the process moves on to S71.

In S71, the IPMC 111 downloads middleware to be downloaded, and performs a middleware start-up management process for making the CPU 113 start the downloaded middleware. Then, the process moves on to S72.

In S72, the IPMC 111 determines whether a value of an app flag is 1. When an application does not need to be downloaded, a value of the app flag is 1, and therefore the determination in S72 is “Yes”, and a series of processes is finished at this point after instructing the CPU 113 to start an application. When a value of the app flag is 0, the determination in S72 is “No”, and the process moves on to S73.

In S73, the IPMC 111 downloads an application to be downloaded, and performs an application start-up management process for making the CPU 113 start the downloaded application. Then, a series of processes is finished.

As described above, from among an OS, middleware, and an application, a program that is specified by the start-up management table 1115 is downloaded. Therefore, a maintenance person can change only a needed program from among programs executed by the CPU 113 of the server blade 11.

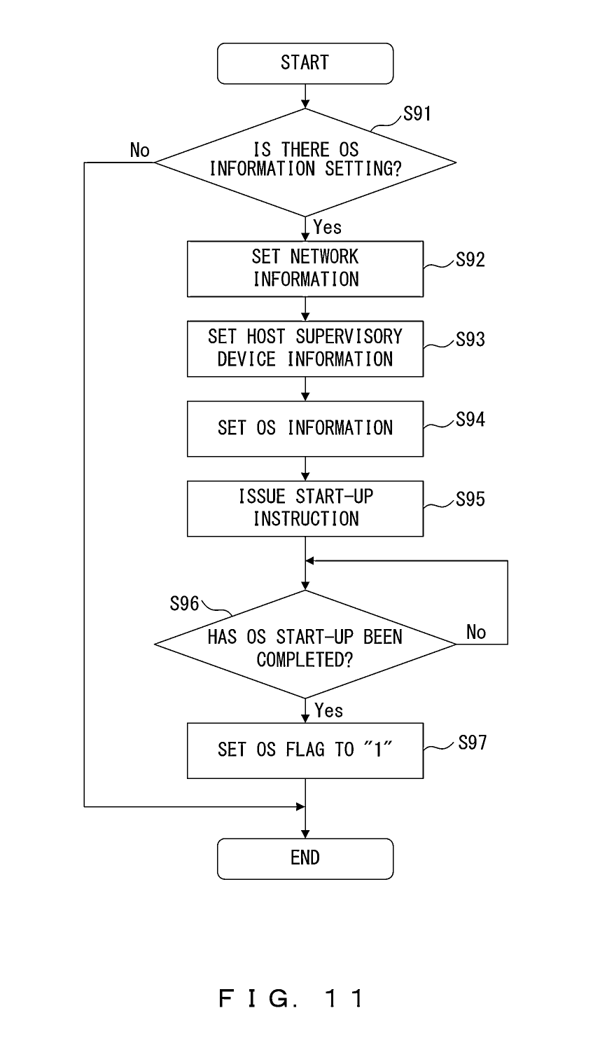

FIG. 11 is a flowchart of the OS start-up management process. Next, with reference to FIG. 11, the OS start-up management process is described in detail.

First, the IPMC 111 determines whether program information of a target server blade 11 includes OS information (S91). When the OS information is included in the program information, the determination in S91 is “Yes”, and the process moves on to S92. When the OS information is not included in the program information, the determination in S91 is “No”, and the OS start-up management process is finished at this point.

In S92, the IPMC 111 sets network information in chassis information 14a, that is, the IPMC 111 reports the network information to the CPU 113. Next, the IPMC 111 sets host supervisory device information and OS information in the chassis information 14a (S93 and S94), and issues a start-up instruction to the CPU 113 (S95).

The CPU 113, which receives the start-up instruction, downloads from the host supervisory device 2 an OS that needs to be downloaded using the set network information, host supervisory device information, and OS information, and stores the downloaded OS in the hard disk device 119. Then, the CPU 113 starts the stored OS.

The IPMC 111, which has issued the start-up instruction, waits for the completion of the start-up of the OS by the CPU 113 (S96). After the start-up of the OS has been completed, the IPMC 111 updates a value of the OS flag in the start-up management table 1115 to 1. Then, the OS start-up management process is finished.

The flows of the middleware start-up management process performed in S71 and the application start-up management process performed in S73 are basically the same as those of the OS start-up management process described above. The middleware start-up management process and the application start-up management process have processing content different from that of the OS start-up management process in S91, S94, S96, and S97.

In the OS start-up management process, OS information is confirmed in S91, whereas in the middleware start-up management process, middleware information is confirmed, and in the application start-up management process, application information is confirmed. In the OS start-up management process, OS information is set in S94, whereas in the middleware start-up management process, middleware information is set, and in the application start-up management process, application information is set. In the OS start-up management process, the completion of the start-up of an OS is waited for in S96; whereas, in the middleware start-up management process, the completion of the start-up of middleware is waited for, and in the application start-up management process, the completion of the start-up of an application is waited for. In the OS start-up management process, a value of an OS flag is updated to 1 in S97; whereas, in the middleware start-up management process, a value of a mid flag is updated to 1, and in the application start-up management process, a value of an app flag is updated to 1. These are all of the differences, and therefore flowcharts of the middleware start-up management process and the application start-up management process are omitted.

FIGS. 12A and 12B are sequence diagrams illustrating an exemplary flow of operations that are respectively performed by a host supervisory device, and a management board and a server blade of a blade server, when a maintenance person does not change chassis information. For convenience, FIGS. 12A and 12B illustrates an exemplary flow of operations after the management card 13 reads chassis information 14a from the CDM 14, i.e., operations after the IPMC 131 in the management card 13 performs the process of S44 of FIG. 9B. An operation of the server blade 11 is illustrated by being divided into the operations of the IPMC 111 and the CPU 113. Next, with reference to FIGS. 12A and 12B, operations of the host supervisory device 2, and the management board 13 and the server blade 11 of the blade server 1 are described in detail for a case in which a maintenance person does not change chassis information 14a.

The IPMC 131 in the management card 13 performs the process of S44 of FIG. 9B, and obtains, from the CDM 14, pieces of information in the order of host supervisory device information, network information, OS information, middleware information, and application information (SQ11-SQ15). Then, the IPMC 131 performs an information comparison determination process for comparing the obtained pieces of information with pieces of information stored in the IPMC 131 and for specifying a changed piece of information (SM1). The information comparison determination process is a process including the processes of S46-S48 of FIG. 9B. It is assumed in this example that the chassis information 14a in the CDM 14 has not been changed, and therefore the IPMC 131 does not clear the start-up management table 1115 of the server blade 11.

After the IPMC 131 performs the information comparison determination process, the IPMC 111 in the server blade 11 performs a management flag determination process (SI1). The management flag determination process is a process in which the processes of S68, S70, and S72 of FIG. 10B are combined. Here, no flags in the start-up management table 1115 have been cleared, and therefore the IPMC 111 makes the CPU 113 sequentially start an OS, middleware, and an application (SC1-SC6).

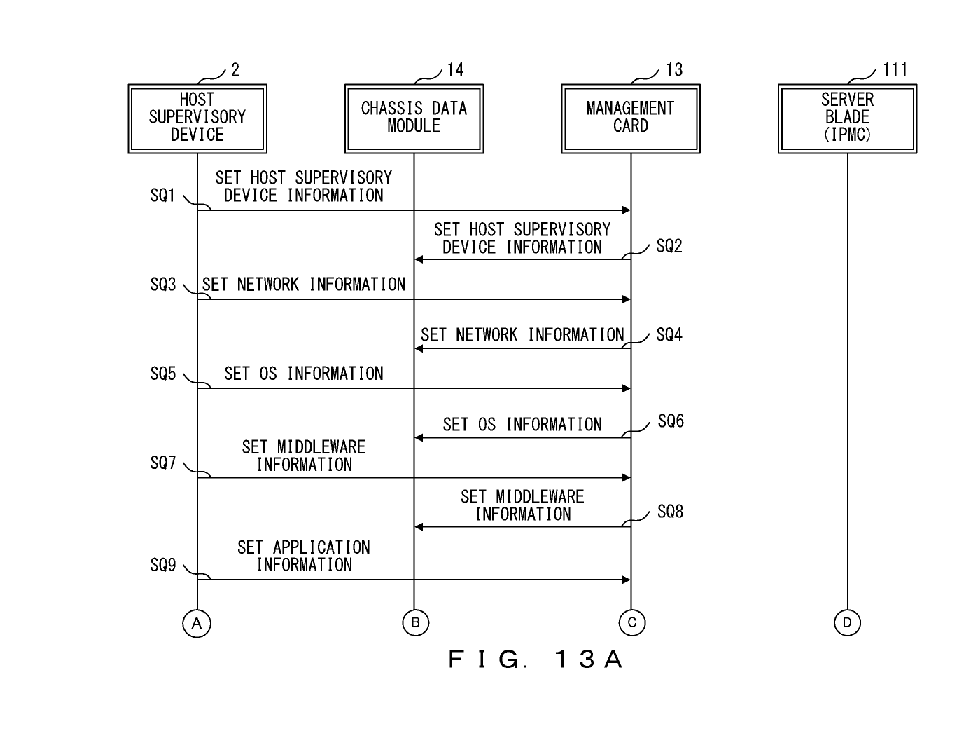

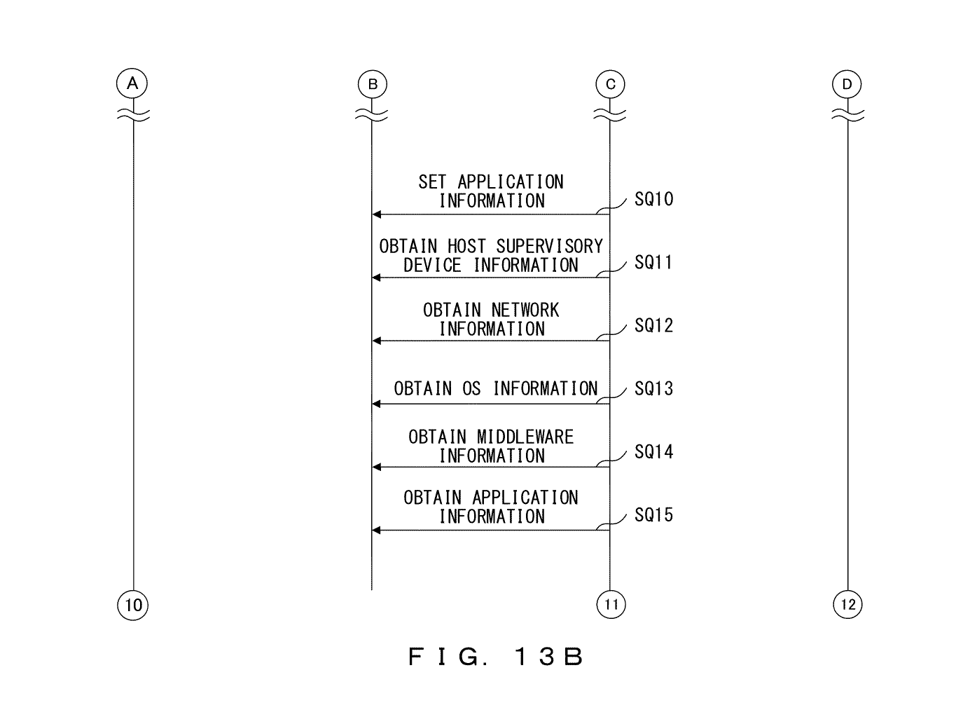

FIGS. 13-15 are sequence diagrams illustrating an exemplary flow of operations that are respectively performed by a host supervisory device, and a management board and a server blade of a blade server, when a maintenance person changes chassis information. In these sequence diagrams, a portion after the management card 13 updates the chassis information 14a of the CDM 14, i.e., after the IPMC 131 performs the process of S32 of FIG. 9A, but before the IPMC 131 reads the chassis information 14a of the CDM 14, is omitted for convenience. This is because this portion is the same as that of the conventional technology. Next, with reference to FIGS. 13-15, operations of the host supervisory device 2, and the management board 13 and the server blade 11 of the blade server 1, in a case in which a maintenance person changes chassis information 14a are described in detail.

In FIGS. 13A and 13B, it is assumed that program information is changed in the order of network information, OS information, middleware information, and application information, after a change in host supervisory device information. Under this assumption, every time information is changed, the host supervisory device 2 issues (transmits) an update instruction to the management card 13 so as to request that the blade server 1 set the information (SQ1, SQ3, SQ5, SQ7, and SQ9). Then, the management card 13 rewrites corresponding information in the chassis information 14a stored in the CDM 14 in accordance with the update instruction (SQ2, SQ4, SQ6, SQ8, and SQ10).

After the process of S44 of FIG. 9B is performed, the IPMC 131 in the management card 13 obtains, from the CDM 14, pieces of information in the order of host supervisory device information, network information, OS information, middleware information, and application information (SQ11-SQ15). Then, the IPMC 131 performs an information comparison determination process (SM1).

Here, it is assumed that the chassis information 14a in the CDM 14 has been changed, as described above. Therefore, the IPMC 131 sets pieces of information in the server blade 11 in the order of host supervisory device information, network information, OS information, middleware information, and application information (SQ21-SQ25). In addition, the IPMC 131 clears at least one flag in the start-up management table 1115 of the server blade 11 in accordance with a changed piece of information in the program information (SQ26).

In this example, it is assumed that the IPMC 131 clears all flags in the start-up management tables 1115. Under this assumption, the IPMC 111 in the server blade 11 makes the CPU 113 sequentially install and start an OS, middleware, and an application.

In order to install an OS, the IPMC 111 sets pieces of information in the CPU 113 in the order of host supervisory device information, network information, and OS information (SQ27-SQ29). After setting the pieces of information, the IPMC 111 issues an OS start-up instruction to the CPU 113 (SQ30).

In response to the OS start-up instruction, the CPU 113 downloads the OS (OS file) from the host supervisory device 2 using respective set pieces of information (SQ31).

After the download of the OS, the CPU 113 installs the downloaded OS; in other words, the CPU 113 stores the downloaded OS in the hard disk device 119 (SC11), and the CPU 113 starts the downloaded OS (SC12 and SC13).

The IPMC 111 monitors the OS start-up by the CPU 113 (SQ32), and confirms the completion of the OS start-up. The IPMC 111, which has confirmed the completion of the OS start-up, sets a value of an OS flag in the start-up management table 1115 to 1 (SI12).

The IPMC 111 and the CPU 113 perform similar operations on middleware and an application (SQ33-SQ44, SI13, SI14, and SC14-SC19). As a result, the CPU 113 downloads and installs each of the middleware and the application, and starts each of the middleware and the application that have been installed. The CPU 113 performs the installation and start-up of the middleware and the application such that each value of amid flag and an app flag in the start-up management table 1115 is updated to 1.

In this embodiment, an information processing system is assumed to be a blade server 1 in which server blades 11 are housed in a chassis (housing device); however, the information processing system may include a plurality of servers (information processing devices) that are housed in a rack. Therefore, a housing device is not limited to a chassis, nor is an information processing device limited to a server blade.

In addition, in this embodiment, needed programs are downloaded (installed) when the server blade 11 is started; however, processes other than the download of programs, e.g., various setting, may be performed. Chassis information 14a used for the download of programs may have a configuration that is different from the configuration illustrated in FIG. 5. Only information needed for the download of programs may be gathered separately from the chassis information 14a.

The chassis information 14a in the blade server 1 is updated under the control of the host supervisory device 2; however, a maintenance person may update the chassis information 14a by manual operation using a console, a terminal device, or the like. Therefore, the update of the chassis information 14a is not limited to this embodiment.

Various modifications other than the modifications above can be made.

When the present embodiment is applied, newly added information processing devices such as server blades or servers can be maintained more rapidly.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing system comprising:
a plurality of information processing devices housed in a housing device; and
a storage device that is mounted on the housing device and that stores pieces of start-up control information that each specify, for each of the plurality of information processing devices, a process to be performed by each of the plurality of information processing devices at the time of start-up, wherein
an information processing device of the plurality of information processing devices, is configured to
obtain corresponding start-up control information from the pieces of the start-up control information stored in the storage device at the time of the start-up of the information processing device; and
perform a process that is specified by the obtained start-up control information.

2. The information processing system according to claim 1, wherein
a first information processing device that is an information processing device for management that is capable of communicating with a management device via a network is housed in the housing device in addition to the plurality of information processing devices, and
the first information processing device obtains, from the management device, update information indicating content to be updated in the start-up control information stored in the storage device, and updates the start-up control information stored in the storage device using the obtained update information.

3. The information processing system according to claim 1, wherein
the information processing device includes a first storage device that stores execution management information indicating whether the process according to the start-up control information is to be performed, and
the process is performed by the information processing device in accordance with the start-up control information when the execution management information stored in the first storage device indicates an execution of the process.

4. The information processing system according to claim 2, wherein
in response to an update of the start-up control information using the update information obtained from the management device, the first information processing device updates execution management information of an information processing device influenced by the update.

5. The information processing system according to claim 4, wherein
the start-up control information includes, for each of the plurality of information processing devices and for each program executed by each of the plurality of information processing devices, program information for installing each of the programs, and
the execution management information is information indicating whether each of the programs is to be installed.

6. A method for managing an information processing device, the method comprising:
storing, in a storage device mounted on a housing device that is capable of housing a plurality of information processing devices, pieces of start-up control information that each specify, for each of the plurality of information processing devices, a process to be performed by each of the plurality of information processing devices at the time of start-up, and
making the information processing device that is to perform the process specified by the start-up control information from the plurality of information processing devices, perform the process specified by the start-up control information.

7. A management apparatus comprising:
a storage device that stores, for each information processing system including a plurality of information processing devices housed in a housing device, pieces of start-up control information that each specify a process to be performed by each of the plurality of information processing devices included in each of the information processing systems at the time of start-up; and
a processor that executes a process including:
updating the pieces of start-up control information stored in the storage device; and
transmitting, when one of the pieces of start-up control information is updated, to the information processing system corresponding to the updated piece of start-up control information, update information indicating content to be updated in start-up control information stored in the information processing system.
